(19) United States
(12) Patent Application Publication
(10) Pub. No.: US 2025/0138828 A1
(43) Pub. Date: May 1, 2025

(54) PIPELINE OPTIMIZATION WITH VARIABLE LATENCY EXECUTION

(71) Applicant: Akeana, Inc., Santa Clara, CA (US)

(72) Inventors: Ricardo Ramirez, Sunnyvale, CA (US); Abhijit Sil, Dublin, CA (US)

(73) Assignee: Akeana, Inc., Santa Clara, CA (US)

(21) Appl. No.: 18/932,738

(22) Filed: Oct. 31, 2024

Related U.S. Application Data
(60) Provisional application No. 63/702,192, filed on Oct. 2, 2024.
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.

(51) Int. Cl. G06F 9/38

(52) U.S. Cl. CPC G06F 9/3867; G06F 9/3836; G06F 9/3858

(57) ABSTRACT

Disclosed embodiments provide techniques for instruction execution in computer processors. A dispatch unit dispatches instructions to one or more issue queues. Instructions from the issue queues feed into execution pipelines. Each execution pipeline includes instruction queue control logic, and two execution engines. A first execution engine is assigned to variable latency instructions while a second execution engine is assigned to fixed latency instructions. While a variable latency instruction executes, fixed latency instructions can be issued, executed, and completed. When the variable latency instruction finishes execution, a request is issued by the first execution engine to the instruction queue control logic. In response, the instruction queue control logic introduces a stall in a common write-back pipeline, allowing the variable latency instruction to complete. The result of the variable latency instruction is provided to a depending fixed latency instruction via a bypass path.

### RELATED APPLICATIONS

This application claims the benefit of U.S. provisional patent applications “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, and “Non-Blocking Unit Stride Vector Instruction Dispatch With Micro-Operations” Ser. No. 63/702,192, filed Oct. 2, 2024.

Each of the foregoing applications is hereby incorporated by reference in its entirety.

### FIELD OF ART

This application relates generally to computer processors and more particularly to pipeline optimization with variable latency execution.

### BACKGROUND

Computer processors play a crucial role in the overall performance and usability of modern computers. Faster processors lead to faster overall system performance. This means that tasks such as opening applications, loading web pages, and running software can be completed more quickly, which improves user experience and productivity. A fast processor can handle multiple tasks simultaneously with ease. This enables efficient handling of tasks such as editing large files or streaming high-definition media. Furthermore, gaming systems benefit significantly from fast processors. Many modern video games require substantial processing power to render complex graphics, perform simulations, and enable artificial intelligence. A faster processor can provide higher frame rates, reduce lag time, and enhance the gaming experience. Moreover, AI and machine learning applications often require significant computational power. Faster processors, especially those optimized for AI workloads, can accelerate training and inference tasks.

Main categories of processors include Complex Instruction Set Computer (CISC) types, and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions to be executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

The aforementioned tools can contribute to the implementation of processors and/or other integrated circuits such as System-on-Chip (SoC) integrated circuits. SoC integrated circuits are highly versatile and find applications in a wide range of electronic devices and systems. These integrated circuits are designed to incorporate multiple components and functionalities onto a single chip, making them compact, power-efficient, and cost-effective. Processor performance enables a wide variety of applications, including data processing, virtualization, content creation, and security applications, to name a few. Thus, processor performance continues to be an essential factor in the development of new systems and technologies.

### SUMMARY

Processor performance is important in many applications, including mobile devices, wearable technology, consumer electronics, automotive electronics, edge computing, and Internet of Things (IoT), to name a few. For RISC processors, efficient instruction pipelines play a significant role in the overall processor performance and functionality. Efficient instruction pipelines allow for the concurrent execution of multiple instructions, leading to a higher instruction throughput. By separating the execution of instructions into multiple stages, each stage can be optimized for a specific task, resulting in faster instruction processing. Pipelining reduces the time it takes to execute a single instruction by dividing the execution into stages. This allows the processor to start working on the next instruction before the previous one has completed. Shortening the execution time of individual instructions translates to faster overall program execution. One contributing factor to the increased performance is that efficient pipelines enable the exploitation of instruction-level parallelism (ILP), which allows multiple instructions to be in various stages of execution simultaneously. Furthermore, efficient pipelines help maintain a steady flow of instructions through the processor, reducing the likelihood of instruction stalls or bottlenecks. A smooth instruction flow ensures that the processor can consistently operate at its maximum potential.

Disclosed embodiments mitigate the performance problems caused by variable latency instructions. Disclosed embodiments provide techniques for pipeline optimization with variable latency execution. In one or more embodiments, a dispatch unit dispatches instructions to one or more issue queues. Instructions from the issue queues feed into corresponding execution pipelines. Each execution pipeline includes instruction queue control logic and at least two execution engines. A first execution engine is assigned to variable latency instructions while a second execution engine is assigned to fixed latency instructions. With fixed latency instructions, the execution time is deterministic. In embodiments, when a variable latency instruction completes execution in the first execution engine, a request is issued by the first execution engine to the instruction queue control logic. The request indicates that the result of the variable latency instruction is now available. The instruction queue control logic introduces a stall in the pipeline by delaying an instruction to accommodate the result. Thus, the instruction queue control logic performs instruction queue arbitration based on the request, and issues a grant to the first instruction queue once there is a slot (bubble) in the pipeline to accommodate the result of the variable latency instruction. In this way, the result of the variable latency instruction can be provided to the instruction pipeline before it is written to a register file, thereby providing a bypass. The bypass receives the result of the variable latency instruction into the pipeline sooner, saving at least one cycle per variable latency instruction. Over the course of millions of instructions being executed, a significant performance improvement may be achieved with disclosed embodiments.

Disclosed embodiments provide techniques for pipeline optimization with variable latency execution. A dispatch unit dispatches instructions to one or more issue queues. Instructions from the issue queues feed into execution pipelines. Each execution pipeline includes instruction queue control logic and two execution engines. A first execution engine is assigned to variable latency instructions while a second execution engine is assigned to fixed latency instructions. While a variable latency instruction executes, fixed latency instructions can be issued, executed, and completed. When the variable latency instruction finishes execution, a request is issued by the first execution engine to the instruction queue control logic. In response, the instruction queue control logic introduces a stall in a common write-back pipeline, allowing the variable latency instruction to complete. The result of the variable latency instruction is provided to a depending fixed latency instruction via a bypass path.

A processor-implemented method for instruction execution is disclosed comprising: accessing a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline; issuing, by the issue queue, a first operation to a first execution engine within the execution pipeline, wherein the first operation is a variable latency operation; issuing, by the issue queue, one or more additional operations to one or more additional execution engines in the execution pipeline, wherein at least one of the one or more additional operations is a fixed latency operation; requesting, by a control logic, to the issue queue, to complete the first operation, when the first operation finishes execution within the first execution engine; arbitrating, by the issue queue, for an opening, wherein the opening is in the common write-back pipeline; granting, by the issue queue, to complete the first operation, wherein the granting is based on the arbitrating; and completing the first operation, wherein the completing includes inserting, at the opening in the common write-back pipeline, a result of the first operation. In embodiments, the arbitrating comprises halting, by the issue queue, a pick stage for a second operation within the one or more additional operations. In embodiments, the inserting occurs at an execution stage of the common write-back pipeline. In embodiments, the execution stage is a second execution stage. Some embodiments comprise delivering the result of the first operation to an entry of the issue queue occupied by a depending operation, wherein the depending operation includes a dependency on the result of the first operation.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for pipeline optimization with variable latency execution.

FIG. 2 is a flow diagram for granting a request.

FIG. 3 is a block diagram illustrating a multicore processor.

FIG. 4 is a block diagram for a pipeline.

FIG. 5 is a system block diagram for issuing to an execution unit.

FIG. 6 is an execution pipeline diagram for variable latency execution.

FIG. 7 is a block diagram for completion and bypass with a variable latency operation.

FIG. 8 is a system diagram for pipeline optimization with variable latency execution.

### DETAILED DESCRIPTION

Techniques for pipeline optimization with variable latency execution are disclosed. A dispatch unit provides instructions to one or more issue queues, and each issue queue provides instructions to a corresponding execution pipeline. The execution pipeline provides a separate execution engine for variable latency instructions. When the variable latency instruction finishes execution, it issues a request to complete the operation via a common write-back pipeline. The completing can include forwarding the result to a depending operation and writing the result to a register file. A register file is a collection of registers that are used to temporarily store and manipulate data during the execution of instructions. Register files are a component of a processor and play an important role in the processor's data processing capabilities. Register files can include a collection of general-purpose registers (GPRs), which can be used for a wide range of data operations. GPRs can be used for a variety of tasks related to data manipulation and program execution. The GPRs can be used for data storage, operand storage, addressing modes, managing control flow, function parameters and return values, and so on. Disclosed embodiments provide an efficient mechanism for handing variable latency instruction execution, result forwarding, and writeback to GPRs or other registers. This technique maximizes pipeline throughput, thereby improving overall processor performance with variable latency instructions.

Variable latency instructions are common in many instruction set architectures (ISAs). In particular, floating-point instructions and/or vector instructions can introduce variable latency. For example, floating-point division, floating-point square root operations, and so on involve several steps and complex operations to accurately compute the quotient (result) of two floating-point numbers. One step can include operand preparation. This can include aligning the exponents of the two floating-point numbers so that they have the same exponent. Another step can include normalization, which confirms that the mantissa (fractional part) of the divisor is within a designated range. This may be achieved by adjusting the exponent of the divisor and shifting the mantissa accordingly. In one or more embodiments, the actual division operation can be performed using hardware components including, but not limited to, dividers or pipelines dedicated to floating-point arithmetic. The division process can further include subtracting the exponent of the divisor from the exponent of the dividend and then dividing the normalized mantissas. In some embodiments, an iterative or algorithmic approach may be used to calculate the quotient with the desired precision. Post division, a rounding process may be performed. After division, the result may contain more bits of precision than the floating-point format allows. The rounding process can be performed to reduce the precision to the specified format (e.g., single-precision or double-precision).

Moreover, a floating-point division instruction can include overflow and underflow handling. The division result may lead to overflow (result too large to represent) or underflow (result too small to represent) conditions. These exceptional cases need to be detected and handled. In some cases, the result may be represented as infinity or zero, depending on the specific floating-point standard (e.g., the IEEE 754 standard). Further error handling can include NaN (not-a-number) handling, and/or exception handling. In embodiments, NaN is a special floating-point value used to represent the result of certain operations that do not yield a valid numeric value. NaN provides techniques for the processor to signal that a particular operation has produced an undefined or unrepresentable result. NaN serves as a placeholder to indicate that a computation has failed to produce a meaningful numeric value, for various reasons. The final quotient of the floating-point division instruction can be encoded in the chosen floating-point format, which includes the sign bit, exponent, and mantissa. In embodiments, the exponent bias, which is used to represent both positive and negative exponents, is considered when encoding the exponent. The computed quotient can be stored in a floating-point register or used directly in subsequent calculations or operations by using the issue queue arbitration and bypass logic of disclosed embodiments.

Efficient pipeline execution benefits from deterministic behaviors. When it is known a priori how long (how many cycles) an instruction will take to execute, instruction schedulers and/or dispatchers can effectively schedule instructions to optimize resource utilization. However, certain types of instructions can have variable latency, in which case, it is not known a priori how long the instruction will take to complete. Factors that may contribute to the variable latency can include variable operand values. The execution time of some floating-point instructions can vary significantly depending on the values of the operands. For example, dividing a small number by a large number may take fewer cycles than dividing two large numbers.

Variable latency instructions are prevalent in many programs and applications. Examples of such instructions can include, but are not limited to, certain floating-point instructions such as floating-point division, square root operations, exponential and logarithmic operations, vector floating-point instructions, reciprocal instructions, and/or other complex instructions. Such variable latency operations are notoriously difficult to schedule by computer hardware. For example, a fixed latency operation can depend on the result of a variable latency operation. When the completion of the variable latency operation is unknown, it is impossible to efficiently schedule the depending fixed latency operation. It is very likely that one of the two operations will stall in the pipeline, reducing processor performance.

The aforementioned steps can take variable amounts of time, making the scheduling of variable latency instructions extremely challenging, especially when mixed with fixed latency operations that can depend on the result of the variable latency operation. In these situations, it is likely that the fixed latency operation will stall while waiting for the variable latency operation result, thus wasting compute resources and lowering performance. Efficiently handling execution, results forwarding, and completion of variable latency instructions can enable improved performance for applications that rely on such instructions.

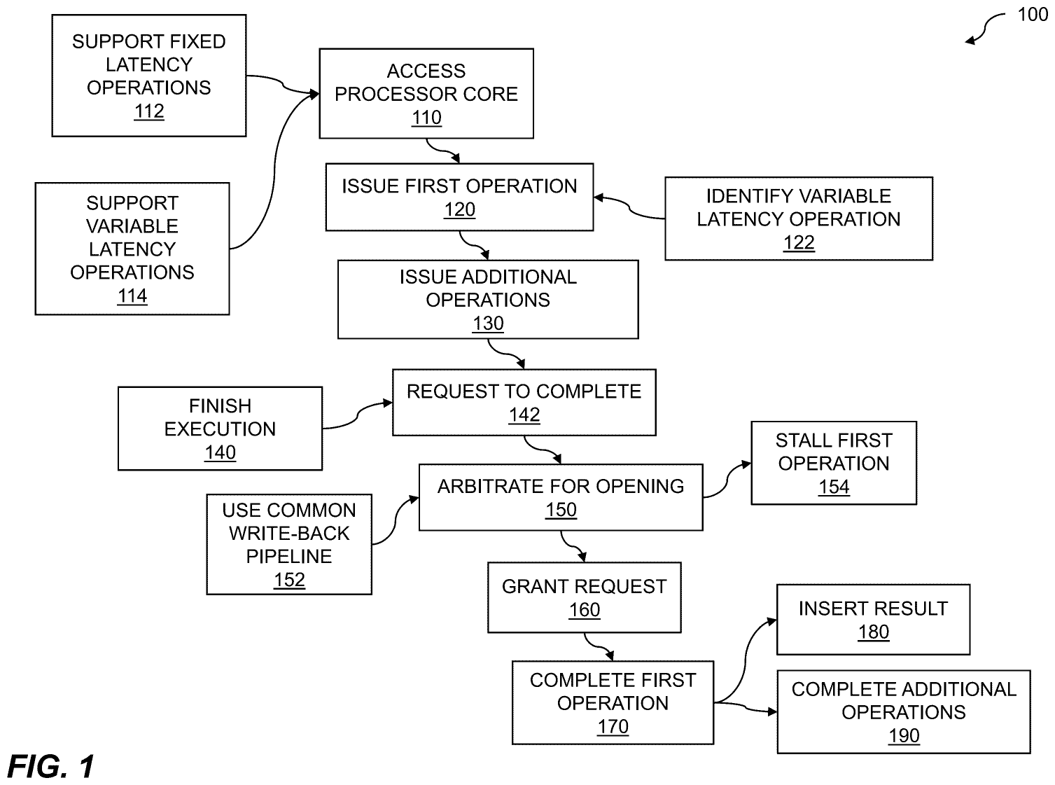

FIG. 1 is a flow diagram for pipeline optimization with variable latency execution. The flow 100 includes accessing a processor core 110, wherein the processor core supports variable latency operations and fixed latency operations, wherein the processor core includes an execution pipeline, wherein the execution pipeline is coupled to an issue queue, and wherein the issue queue is coupled to a common write-back pipeline. The processor core can be included on a multi-processor chip, an application specific integrated circuit (ASIC), a system-on-a-chip (SOC), and so on. The processor core can execute instructions that are part of an instruction set architecture (ISA) such as X86, ARM, RISC-V, and so on. In embodiments, the processor core executes one or more instructions out of order. In other embodiments, the processor core includes one or more additional execution pipelines. In embodiments, each execution pipeline in the one or more additional execution pipelines includes a unique issue queue. Each execution pipeline in the processor core can include one or more execution engines. The flow 100 can include supporting fixed latency operations 112. The fixed latency operations can include instructions such as addition, shifting, and logical instructions such as AND, OR, XOR, and the like. The flow 100 can include supporting variable latency operations 114. The variable latency operations can include floating-point operations such as division, square root operations, reciprocal operations, logarithmic operations, exponent operations, and so on. In embodiments, the execution engines execute instructions from the ISA. In embodiments, the execution engines can execute either a variable latency operation or a fixed latency operation. In embodiments, the common write-back pipeline provides a path for all execution units coupled to the issue queue to write results to a register file. Forwarding of results to depending instructions can also be handled by the common write-back pipeline.

The flow 100 includes issuing, by the issue queue, a first operation 120 to a first execution engine within the execution pipeline, wherein the first operation is a variable latency operation. The processor core can include any number of issue queues. In embodiments, each issue queue is coupled to one or more execution engines, which are capable of executing one or more instructions from the ISA. In embodiments, the variable latency operation is identified 122 by the issue queue. The identifying can occur prior to the issuing so that the variable latency operation is sent to an execution engine capable of executing a variable latency operation.

In embodiments, the issue queue attempts to maximize throughput of the one or more execution engines to which it issues operations. The flow 100 further includes issuing, by the issue queue, one or more additional operations 130 to one or more additional execution engines in the execution pipeline, wherein at least one of the one or more additional operations is a fixed latency operation. The number of variable latency and fixed latency operations that can be issued by the issue queue depends on the number of issue queue entries and the depth of the pipeline. In embodiments, the issue queue includes eight entries. In other embodiments, the issue queue includes 16 entries. Any number of issue queue entries can be included. In embodiments, any issue queue entry processes either a variable latency operation or a fixed latency operation and directs them to the appropriate execution engine within the execution pipeline.

The flow 100 includes finishing execution 140 of the first operation. The finishing execution indicates that the execution engine that was issued the first operation, which was a variable latency operation, has completed. In embodiments, the number of processor cycles required to complete the execution of the variable latency instruction is unknown. When execution is finished, the result of the variable latency operation can be made available. The flow 100 further includes requesting, by a control logic, to the issue queue, to complete 142 the first operation, when the first operation finishes execution within the first execution engine. In embodiments, the control logic is included in the first execution engine. The control logic can signal to the issue queue that the first operation has finished executing and needs to complete. Completion of an operation can include writing back results and forwarding results to depending operations. In embodiments, completing the first operation is not accomplished by the first execution engine that executed the variable latency operation. Instead, the requesting by the control logic causes the issue queue to complete the first operation through the use of a common write-back pipeline. In embodiments, the write-back pipeline is coupled to the issue queue and handles completion of all operations processed by the issue queue.

The flow 100 includes arbitrating, by the issue queue, for an opening 150, wherein the opening is in the common write-back pipeline. The arbitrating can be in response to the requesting. The arbitrating can create a slot or “bubble” in the common write-back pipeline 152, where the result of the variable latency operation can be inserted to complete the operation. This can include writing back the result to a register file, such as a general purpose register file (GPR), floating point register file (FPR), vector register file (VRF), and so on. In embodiments, the result of the first operation is provided through a bypass mechanism. The bypass mechanism can forward the result of the first operation to depending instructions in the pipeline, thereby delivering the result earlier, bypassing the writing (and subsequent reading) of the result to a register file. The writing of the result to a register file can still occur, but the pipeline can continue execution using the bypassed result. In embodiments, the arbitrating comprises stalling the first operation 154. The stalling can include inserting wait cycles by the issue queue logic. The stalling can include adding wait states, no-op instructions, and/or other techniques to hold the variable latency instruction until the arbitration creates a slot in the common write-back pipeline in which to complete the first operation.

The flow 100 includes granting the request 160, by the issue queue, to complete the first operation, wherein the granting is based on the arbitrating. Once the issue queue successfully creates an opening in the common write-back pipeline, the issue queue can grant the request from the control logic to complete the first operation. As previously mentioned, the issue queue can attempt to maximize throughput of the one or more execution engines to which it issues operations. In embodiments, the issue queue cannot schedule around a variable latency operation since it is not known when the variable latency operation will finish once issued to an execution engine. Thus, once the variable latency operation finishes execution, the issue queue can be forced to insert bubbles into the execution pipeline, lowering throughput. The aforementioned request, arbitrate, and grant mechanism can increase processor performance by avoiding unexpected bubbles in the execution pipeline. Instead, this allows the issue queue to schedule the variable latency operation into the common write-back pipeline after the variable latency operation has finished executing.

The flow 100 further includes completing the first operation 170, wherein the completing includes inserting 180, at the opening in the common write-back pipeline, a result of the first operation. Once the issue queue arbitrates for an opening in the common write-back pipeline and grants the request by the control logic, the result of the first operation can be sent into the common write-back pipeline for completion. As previously described, completing the first operation can include writing back the result to a register file and bypassing results of the first operation to depending instructions in the pipeline. In embodiments, the issue queue schedules the completing of the first operation in the common write-back pipeline in between other fixed latency operations that are completing from within the common write-back pipeline. In embodiments, the inserting occurs at an execution stage of the common write-back pipeline. In embodiments, the execution stage is a second execution stage. In embodiments, the pipeline stages include pick, read, execute, and writeback stages. The execution engine can have any number of pipeline stages. In embodiments, the execution includes three stages. Thus, the pipeline can include PK (pick), R (read), E1 (execute 1), E2 (execute 2), E3 (execute 3), and WB (writeback). In embodiments, the result of the first operation can be inserted into the second execution engine at the E2 stage. In further embodiments, the result continues to flow down the common write-back pipeline via the E3 and WB stages.

The flow 100 can further include completing the one or more additional operations 190 that were issued by the issue queue to one or more execution engines in the pipeline. The one or more additional operations can include one or more additional fixed latency operations. In embodiments, the one or more additional operations include another variable latency instruction. In this case, execution and completion of the variable latency operation is handled according to the aforementioned mechanisms. In embodiments, the requesting, the arbitrating, the granting, and the completing include a second variable latency operation.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

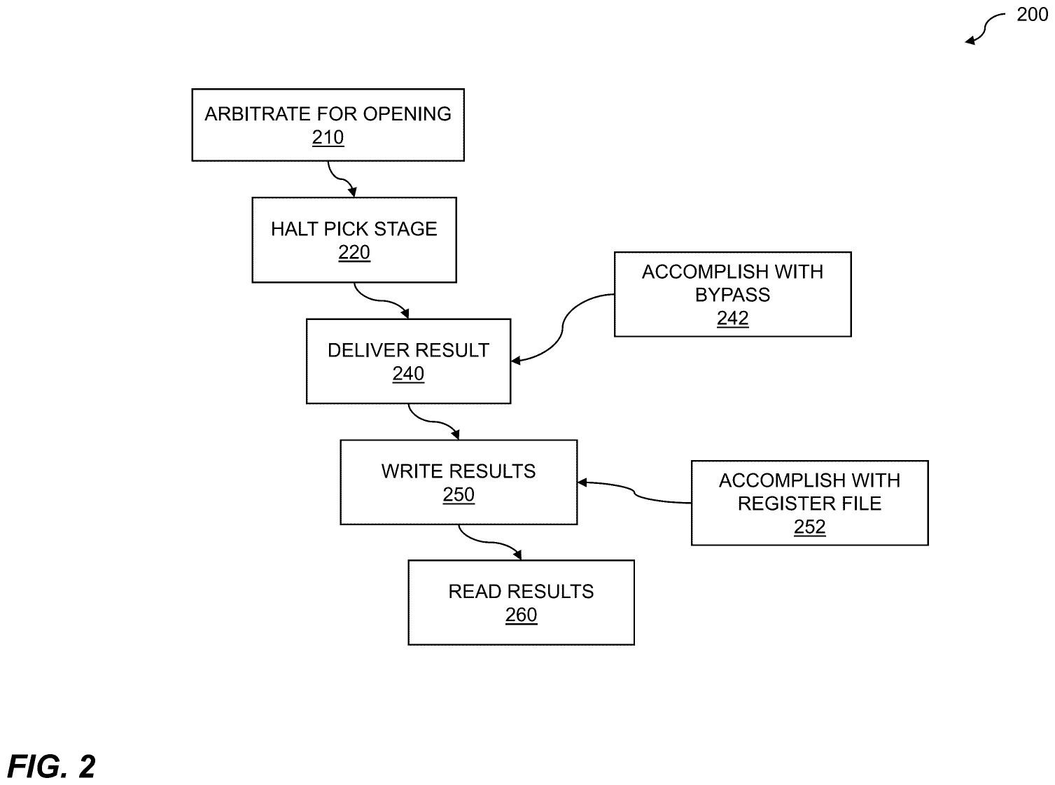

FIG. 2 is a flow diagram for granting a request. The flow 200 can include arbitrating, by the issue queue, for an opening 210, wherein the opening is in the common write-back pipeline. The arbitrating can create a slot or “bubble” in the common write-back pipeline where the result of the variable latency operation can be inserted to complete the operation. During the arbitration, the first operation (the variable latency operation), can stall in the first execution engine. As previously described, the stalling can include adding wait states, no-op instructions, and/or other techniques to hold the variable latency instruction until the arbitration creates a slot in the common write-back pipeline in which to complete the first operation.

The flow 200 further includes halting, by the issue queue, a pick stage 220 for a second operation within the one or more additional operations. In embodiments, the pick stage includes picking an operation from an issue queue entry to be inserted into the second execution engine. By halting the picking of the second operation, a downstream bubble is created in the common write-back pipeline that would otherwise have received the second operation. The arbitration can include the halting.

The flow 200 further can include delivering the result 240 of the first operation to an entry of the issue queue occupied by a depending operation, wherein the depending operation includes a dependency on the result of the first operation. Another operation in the issue queue can depend on the result of the first operation. Thus, the result of the first operation can be delivered to the depending operation as it flows through the common write-back pipeline. In embodiments, the delivering is accomplished by a bypass path 242 in the common write-back pipeline. The bypass can occur in one of the execution stages of the common write-back pipeline. In embodiments, the bypass occurs in the E2 (second execution) stage of the common write-back pipeline. In other embodiments, the bypass occurs at in the E3 (third execution) stage of the common write-back pipeline. In further embodiments, the bypass occurs in the writeback stage of the common write-back pipeline. The bypass can save one or more clock cycles for each variable latency instruction, as the result of the variable latency instruction can be provided to the depending instruction without needing to first write the results to a register file.

The flow 200 can further include writing the results 250 of the first operation, in a writeback stage of the common write-back pipeline, to a register file 252. As previously stated, the register file 252 can include a general purpose register file (GPR), floating point register file (FPR), vector register file (VRF), and so on. The writing to a register file can maintain expected values in registers that are exposed to applications and/or programs, thereby ensuring correct results of executing programs and tasks. Other embodiments include reading, from the register file, the results 260 of the first operation. The reading can be accomplished by a depending operation which requires the result of the variable latency operation as an operand.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

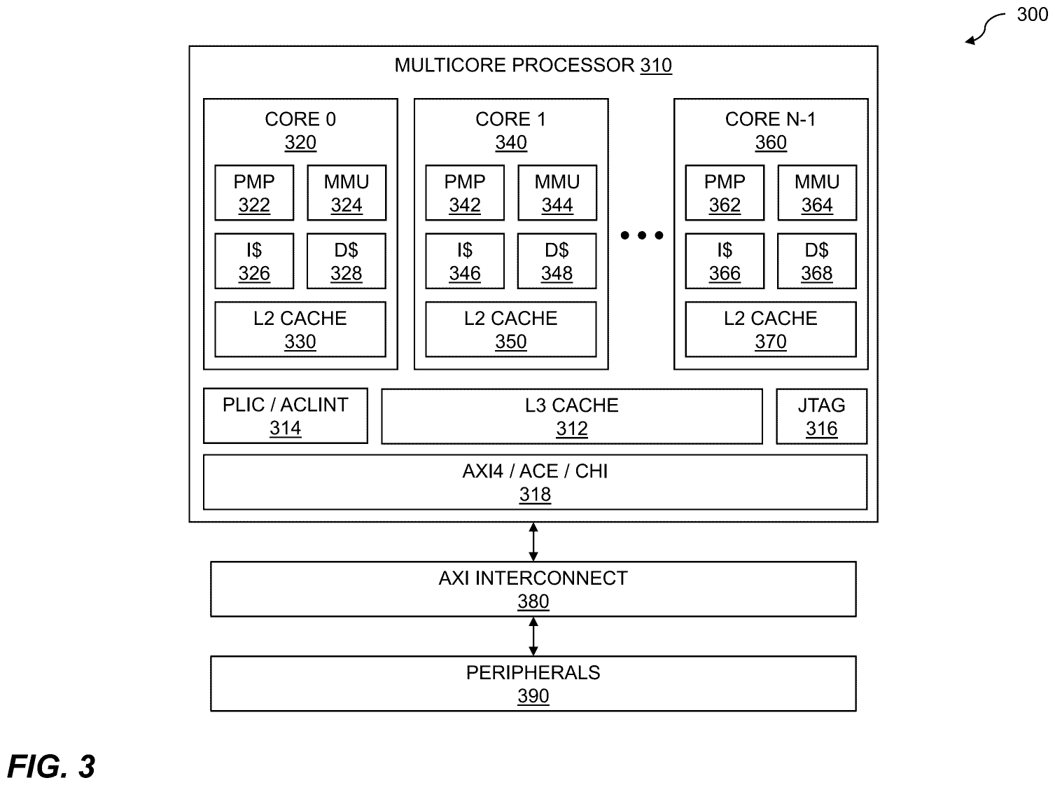

FIG. 3 is a block diagram illustrating a multicore processor. The processor, such as a RISC-V™ processor, ARM processor, or other suitable processor type, can include a variety of elements. The elements can include processor cores, one or more caches, memory protection and management units, local storage, and so on. In embodiments, the processor core executes one or more instructions out of order. The elements of the multicore processor can further include one or more of a private cache; a test interface such as a joint test action group (JTAG) test interface; one or more interfaces to a network such as a network-on-chip, shared memory, and/or peripherals; and the like. The multicore processor is enabled by coherency management using distributed snoop. Snoop requests are ordered in a two-dimensional matrix, wherein the two-dimensional matrix is extensible along each axis of the two-dimensional matrix. Snoop responses are mapped to a first-in first-out (FIFO) mapping queue, wherein each snoop response corresponds to a snoop request, and wherein each processor core of the plurality of processor cores is coupled to at least one FIFO mapping queue. A memory access operation is completed, based on a comparison of the snoop requests and the snoop responses.

In block diagram 300, a multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1 can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include L2 cache 330 associated with core 0; L2 cache 350 associated with core 1; and L2 cache 370 associated with core N-1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an Advanced Core Local Interrupt (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced extensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

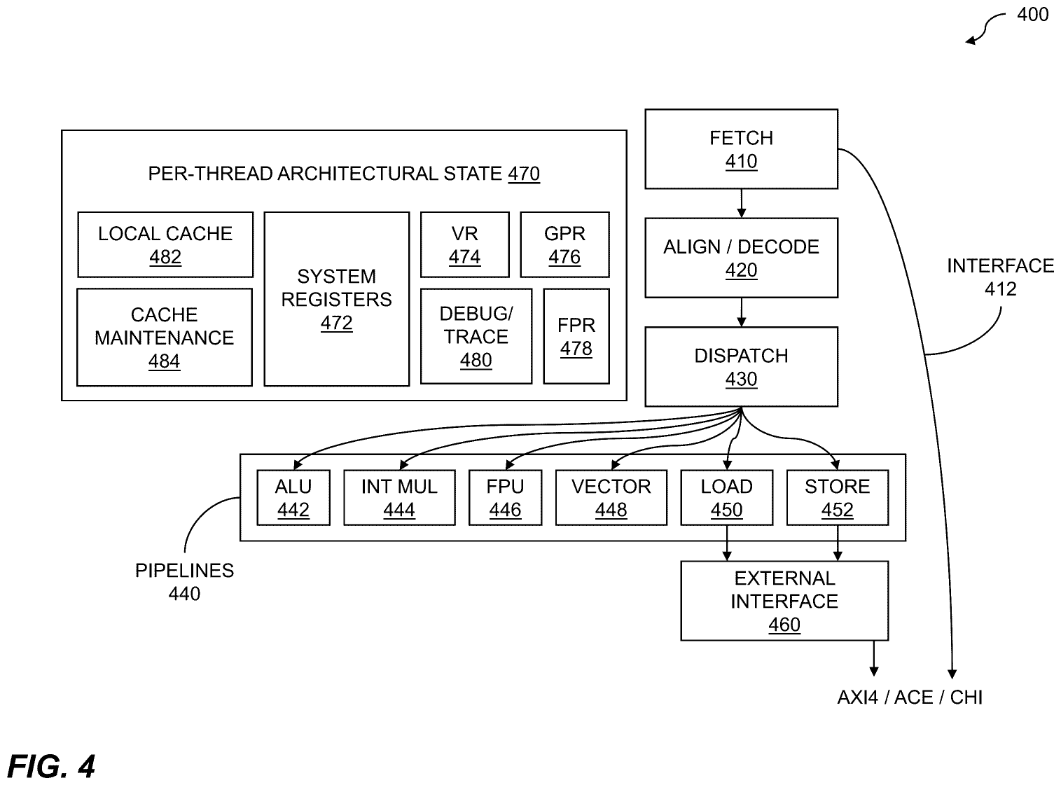

FIG. 4 is a block diagram for a pipeline. The use of one or more pipelines associated with a processor architecture can greatly enhance processing throughput. The processor architecture can be associated with one or more processor cores. The processing throughput can be increased because multiple operations can be executed in parallel. In embodiments, a plurality of processor cores is accessed, where the processors perform pipeline optimization with variable latency execution.

The blocks within the block diagram can be configurable in order to provide varying processing levels. The varying processing levels can be based on processing speed, bit lengths, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The system block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. In embodiments, the width of the vector register file is 512 bits. Additional registers such as general-purpose registers (GPR) 476 and floating-point registers (FPR) 478 can be included. These registers can be used for general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

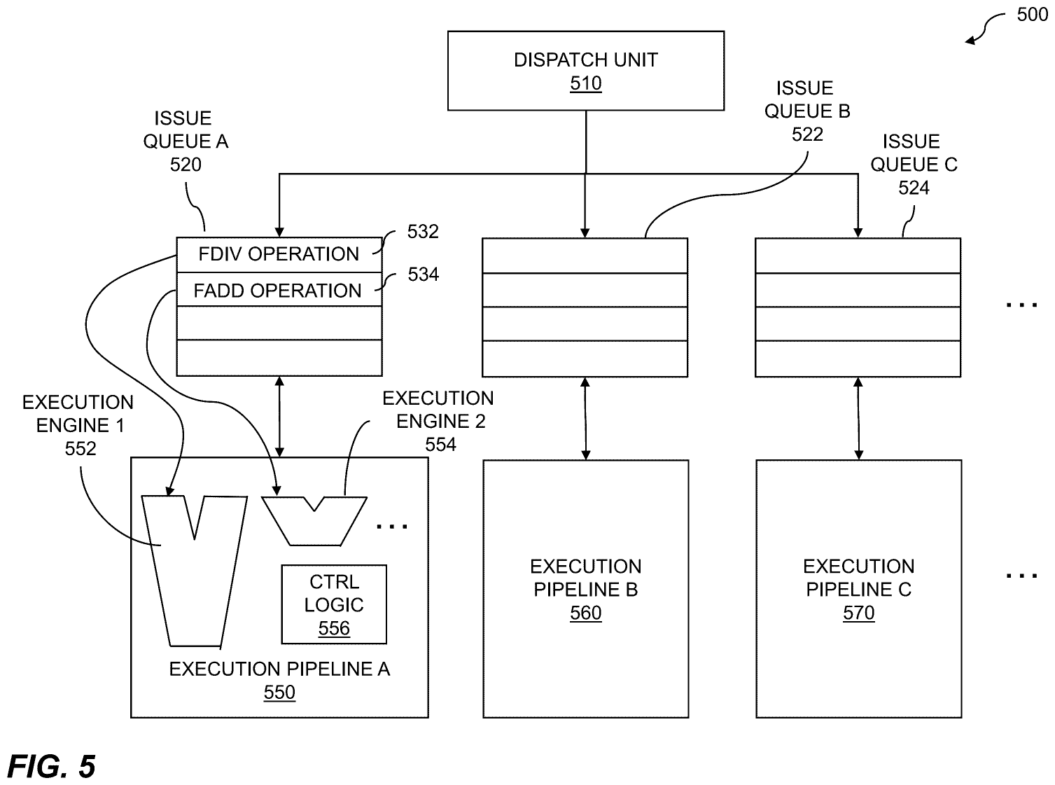

FIG. 5 is a system block diagram for issuing to an execution unit. The system 500 includes a dispatch unit 510. The dispatch unit 510 receives instructions that were fetched and decoded by the processor core, and sends the instructions to one or more issue queues. In system 500, three issue queues are shown, indicated as issue queue A 520, issue queue B 522, and issue queue C 524. While three issue queues are shown in system 500, other embodiments may have more or fewer issue queues. Each issue queue has a corresponding depth, indicating the number of entries in the queue. In one or more embodiments, the depth is a fixed value. As shown in FIG. 5, there are four entries in each issue queue, indicating a depth of four. In practice, the depth of each queue can be a different value. In one or more embodiments, the depth of each queue is a value ranging from 8 to 256. In embodiments, each issue queue has the same depth. In other embodiments, the issue queues have different depths. As an example, issue queue A 520 can have a depth of 32, issue queue B 522 can have a depth of 64, and issue queue C 524 can have a depth of 128. In embodiments, each issue queue corresponds to a different category of instruction. As an example, issue queue A 520 can correspond to floating-point instructions, issue queue B 522 can correspond to integer instructions, and issue queue C 524 can correspond to vector instructions. Each issue queue may contain one or more fixed latency instructions and/or one or more variable latency instructions. In embodiments, each execution pipeline in the one or more additional execution pipelines includes a unique issue queue. In embodiments, each issue queue is coupled to a common write-back pipeline to provide a mechanism for completing all operations processed by the issue queue.

Referring now to issue queue A 520, two instructions are shown. Instruction 532 represents a floating-point division (FDIV) operation, which can be a variable latency operation. Instruction 534 represents a floating-point add (FADD) operation, which can be a fixed latency operation. The FADD operation can depend on the results of the FDIV operation. Each issue queue is coupled to a corresponding execution pipeline. Issue queue A 520 is coupled to execution pipeline A 550. Similarly, issue queue B 522 is coupled to execution pipeline B 560, and issue queue C 524 is coupled to execution pipeline C 570. Each of the execution pipelines can include one or more execution engines that receive operations to be executed by the related issue queue. Referring now to execution pipeline A 550, additional detail is shown, including instruction queue control logic 556, execution engine 1 552, and execution engine 2 554. One or more execution engines can be designated to execute variable latency operations, such as execution engine 1 552 in system 500. One or more execution engines can be designated to execute fixed latency operations, such as execution engine 2 554 in system 500. In embodiments, instructions are picked from issue queue A 520, and the picked instructions are routed to the appropriate execution engine. In one or more embodiments, the criteria for routing to a given execution engine can be based on an instruction op code. In one or more embodiments, an operation, such as the FDIV operation, is designated as a variable latency instruction and thus will be issued by the issue queue to execution engine 1. Other instruction types can be designated as fixed latency instructions, such as the FADD operation instruction 534, which has been assigned to execution engine 2 554 within execution pipeline A 550. In one or more embodiments, instructions such as floating-point division instructions, floating-point square root instructions, logarithmic instructions, trigonometric function instructions, and exponent instructions are deemed to be variable latency instructions, and can be dispatched to the variable latency execution engine 1 552. Similarly, instructions such as floating-point addition and subtraction instructions can be deemed to be fixed latency instructions, and are accordingly dispatched to the fixed latency execution engine 2 554.

Instructions executing in execution engine 2 554 are fixed latency operations, and thus, are deterministic in terms of execution time. Conversely, instructions executing in execution engine 1 552 are variable latency operations, and thus, are nondeterministic regarding execution time. In one or more embodiments, once a variable latency execution instruction finishes execution, the execution engine 1 552 can notify the control logic 556. The control logic 556 can then make a request to the issue queue to complete the variable latency operation. In response, issue queue A 520 can examine the issue queue entries, pipeline stages within execution engine 2, and so on. The issue queue can then determine when a slot (bubble) is available for the result from the variable latency execution engine 1 552 to be inserted into the common write-back pipeline. Once an upcoming slot is available, issue queue A can grant the request, and the result from the variable latency execution engine 1 552 can be provided to the common write-back pipeline. In some embodiments, issue queue A examines pipeline stages and actively creates a slot. This can include delaying one or more instructions destined for the fixed latency execution engine 2 554, or delaying the completion of a variable latency instruction in execution engine 1 552.

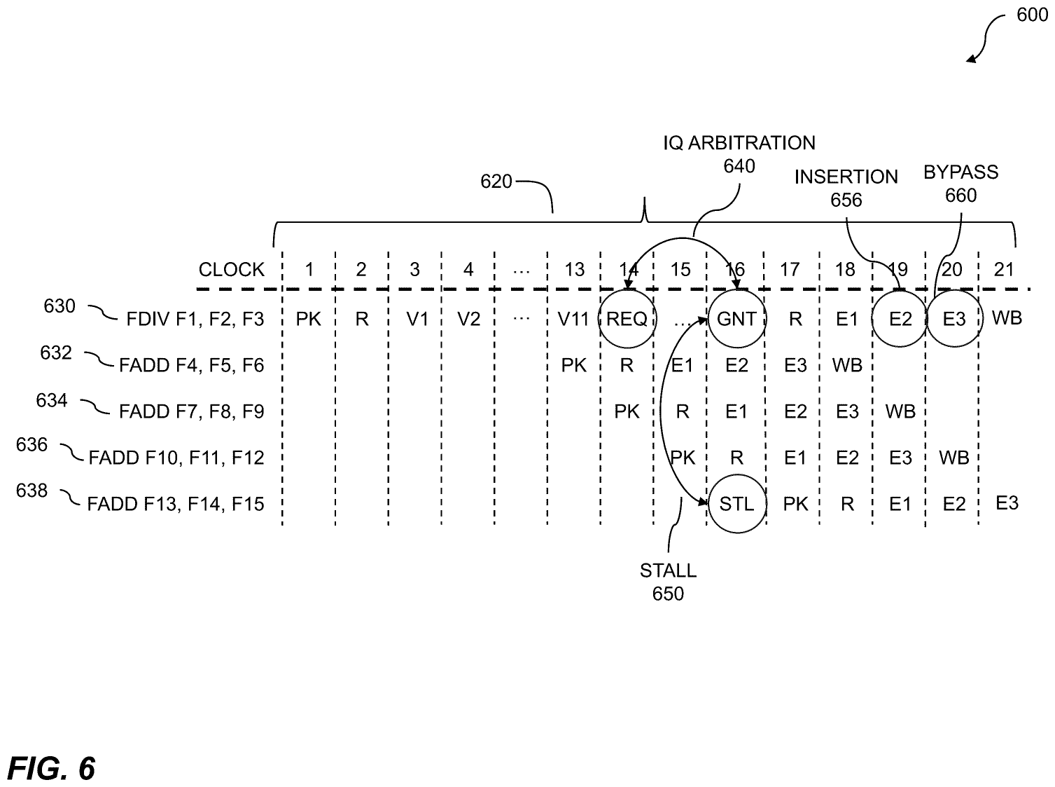

FIG. 6 is an execution pipeline diagram for variable latency execution. The diagram 600 includes multiple clock cycles 620. The diagram 600 further includes multiple instructions, with each instruction at different stages of execution. The instructions include a first operation which is a floating-point divide (FDIV) instruction at 630. The FDIV instruction can be a variable latency operation. The instructions in diagram 600 also include four floating-point add (FADD) instructions, indicated at 632, 634, 636, and 638, which can be fixed latency operations. Thus, in some embodiments, the variable latency operation is a floating-point divide operation. In some embodiments, the variable latency operation is a floating-point square root operation. As can be seen in diagram 600, the clock cycles 620 are represented in columns, and clock cycles 1 through 4 are shown, followed by a discontinuity, followed by clock cycles 13 through 21. The discontinuity is included to represent an extended period of time between clock cycle 4 and clock cycle 13. Because it is a variable latency operation, instruction 630 was issued to an execution engine designated for variable latency operations. Because they are fixed latency operations, instructions 632, 634, 636, and 638 were issued to the same pipelined execution engine designated for fixed latency operations. In practice, the issue queue can issue one or more fixed latency instructions to as many fixed latency execution engines as are available in the execution pipeline. Similarly, the issue queue can issue one or more variable latency instructions to as many variable latency execution engines as are available in the execution pipeline. In embodiments, one fixed latency instruction or one variable latency instruction is issued per clock cycle. Multiple fixed latency and variable latency instructions can be outstanding at any time.

At clock cycle 1, instruction 630 is in the pick stage, indicated by the “PK” at clock cycle 1 for instruction 630. In embodiments, the pick stage is the stage in which an instruction is picked from an issue queue and inserted into an execution engine. At clock cycle 2, instruction 630 is in the read stage, indicated by the “R” at clock cycle 2 for instruction 630. In embodiments, the read stage is the stage in which operands for an instruction are read. At clock cycle 3, instruction 630 is executing a stage, indicated as V1. The “V” stages indicate stages for execution of a variable latency instruction. In practice, there can be multiple “V” stages for execution of a variable latency instruction. Accordingly, at clock cycle 4, instruction 630 is executing an additional execution stage, indicated as V2. Execution of instruction 630 continues up to stage V11, indicated at clock cycle 13 for instruction 630. Thus, in the example shown in FIG. 6, instruction V11 is the final execution stage for instruction 630, after which, the result of instruction 630 is available. Simultaneously, at clock cycle 13, the second instruction, floating-point add (FADD) 632 starts its pick stage, as indicated by the “PK” at clock cycle 13 for instruction 632.

Having finished execution, the result for instruction 630 is now available. After completion of clock cycle 13, control logic can send a request to complete instruction 630 to the issue queue. In response to receiving a request, the control logic can perform issue queue arbitration 640. In embodiments, the arbitrating comprises stalling, by the issue queue, the first operation. The issue queue arbitration can include identifying an upcoming slot and/or making a slot available in a common write-back pipeline. Also occurring at clock cycle 14, instruction 632 performs its read stage, while the next instruction 634 starts its pick stage. Similarly, at clock cycle 15, instruction 632 starts its first execute stage, indicated as “E1” in clock cycle 15, instruction 634 executes its read stage, indicated as “R” in clock cycle 15, and instruction 636 executes its pick stage, indicated as “PK” in clock cycle 15.

Referring again to instruction 630, at clock cycle 15, the instruction stalls, as it is awaiting a grant from the request that was sent in clock cycle 14. In the example of FIG. 6, the grant is received, indicated as “GNT” at clock cycle 16 for instruction 630. As previously discussed, variable latency operations, such as instruction 630, do not complete in the variable latency execution engine to which they were issued. Instead, they can rely on the aforementioned issue queue arbitration to create and utilize a slot created by the issue queue in a common write-back pipeline to complete. Thus, the read indicated at cycle 17 for instruction 630, along with the E1 stage at cycle 18, E2 stage at cycle 19, E3 stage at cycle 20, and write-back stage at cycle 21, represent stages of the common write-back pipeline. In cycle 19, the results from the floating-point division instruction 630 can be inserted 656 into the common write-back pipeline to provide a path for completion for the variable latency instruction 630. The completion can include writing back results of the variable latency operation to a register file and/or forwarding results via a bypass 660 to other instructions depending on its result. Thus, although the writeback for instruction 630 occurs at clock cycle 21, as indicated by “WB”, a dependent instruction can start execution one cycle early, as indicated at stage E3 in clock cycle 20.

Depending on the depth of an execution pipeline and availability of an issue queue entry, the instruction queue control logic may introduce a stall 650 to a subsequent instruction to delay the pick stage of that instruction, to ensure that resources are available for the completion of the variable latency instruction 630. In the example shown in FIG. 6, the issue queue delays execution of the floating-point add (FADD) instruction 638 to create a “bubble” in the common write-back pipeline pipeline. Instructions 632-638 can represent one or more additional operations. Embodiments can include completing the one or more additional operations.

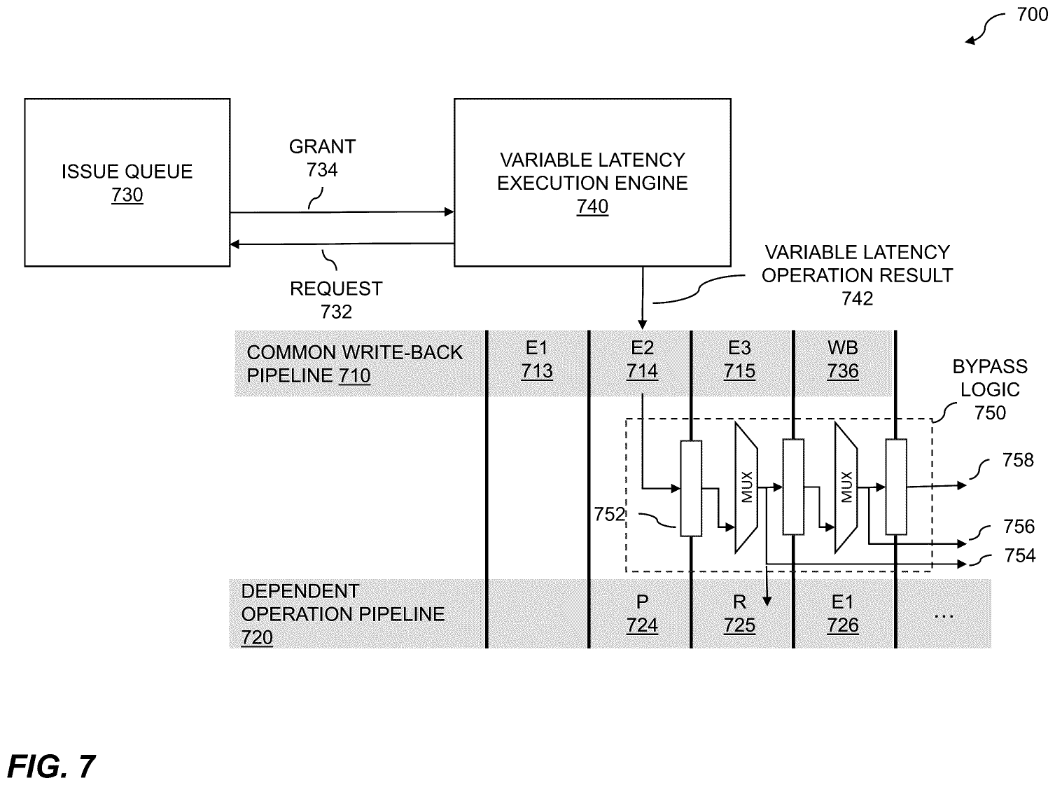

FIG. 7 is a block diagram for completion and bypass with a variable latency operation. The diagram 700 includes a common write-back pipeline 710 that provides results to a dependent operation pipeline 720. In one or more embodiments, the common write-back pipeline can complete variable latency operations including, but not limited to, floating-point division instructions; square root instructions; logarithmic operations; exponent operations; trigonometric computations, such as sine, cosine, tangent; and/or other variable latency instructions. The common write-back pipeline 710 can complete fixed latency operations such as logical operations (AND, OR, XOR, etc.), integer arithmetic operations, conditional evaluation instructions, branching instructions, and so on. In situations where a dependent operation depends on the result of a variable latency completion pipeline, the scheduling of the dependent operation can be quite challenging, since it is difficult to know a priori how many clock cycles the prerequisite variable latency instruction will take to complete. With disclosed embodiments, the need for scheduling these dependent instructions is eliminated, greatly simplifying pipeline management. Explained throughout, an issue queue 730 can issue a variable latency operation to a variable latency execution engine 740. The variable latency execution engine 740 can be used to execute a variable latency operation such as floating-point division instructions, square root instructions, logarithmic instructions, and the like. In some embodiments, execution of the variable latency operation is pipelined. In other embodiments, execution of the variable latency operation is not pipelined. When the execution engine is complete, a request 732 to complete the variable latency operation can be sent by the variable latency execution pipeline to the issue queue. In response to the request, the issue queue can arbitrate for an opening in a fixed latency execution engine pipeline. The arbitrating allows a variable latency operation to be inserted into the common write-back pipeline to complete the variable latency operation. This mechanism not only helps in scheduling dependent operations, but avoids the need for an additional read and/or write port on one or more register files in the processor core. Once an opening is available, the issue queue 730 can grant 734 the request, and the result from the variable latency execution engine 740 can be provided to the common write-back pipeline 710.

The common write-back pipeline 710 can include an intermediate execution stage E1 at 713, where execution of a fixed latency operation can begin. In this case, execution is not required since the pipeline is only being used to complete a result from the variable latency operation. Execution can include additional stages. FIG. 7 shows intermediate execution stage E2 at 714 where execution of a fixed latency operation can continue. In this case, the E2 stage is used to send the variable latency operation result 742 to the common write-back pipeline 710. On the same cycle, a depending instruction, which was scheduled and issued by the issue queue, begins processing in the dependent operation pipeline 720 with a pick stage 724. A pick stage is where an instruction is picked from an issue queue and inserted into an execution engine of a corresponding execution pipeline. Bypass logic 750 can include one or more registers 752 and multiplexors which can make the result from the variable latency operation available to the depending fixed latency operation in the third intermediate execution stage (E3 715) of the fixed latency execution engine pipeline. The E3 stage corresponds to the read stage 725 of the depending fixed latency operation. In the read stage, operands for the instruction are read. In this way, a result from the variable latency operation can be read by the fixed latency operation without having to access a register file. The next stage is write-back 736, corresponding to execution stage E1 726 of the depending fixed latency operation, where the result from the variable latency operation is written into the appropriate register file. The writing to the register file can use the write port in the common write-back pipeline 710, thus alleviating a requirement for the variable latency execution engine 740 to have a separate write port to the register file, saving space and increasing frequency performance of the processor core.

In embodiments, additional signals can be provided from the bypass logic 750. As shown in FIG. 7, the additional signals are indicated as 754, 756, and 758. The additional signals can be coupled to subsequent pipeline stages to enable greater flexibility during instruction queue arbitration. The additional signals can be used to forward a result from the variable latency operation further downstream.

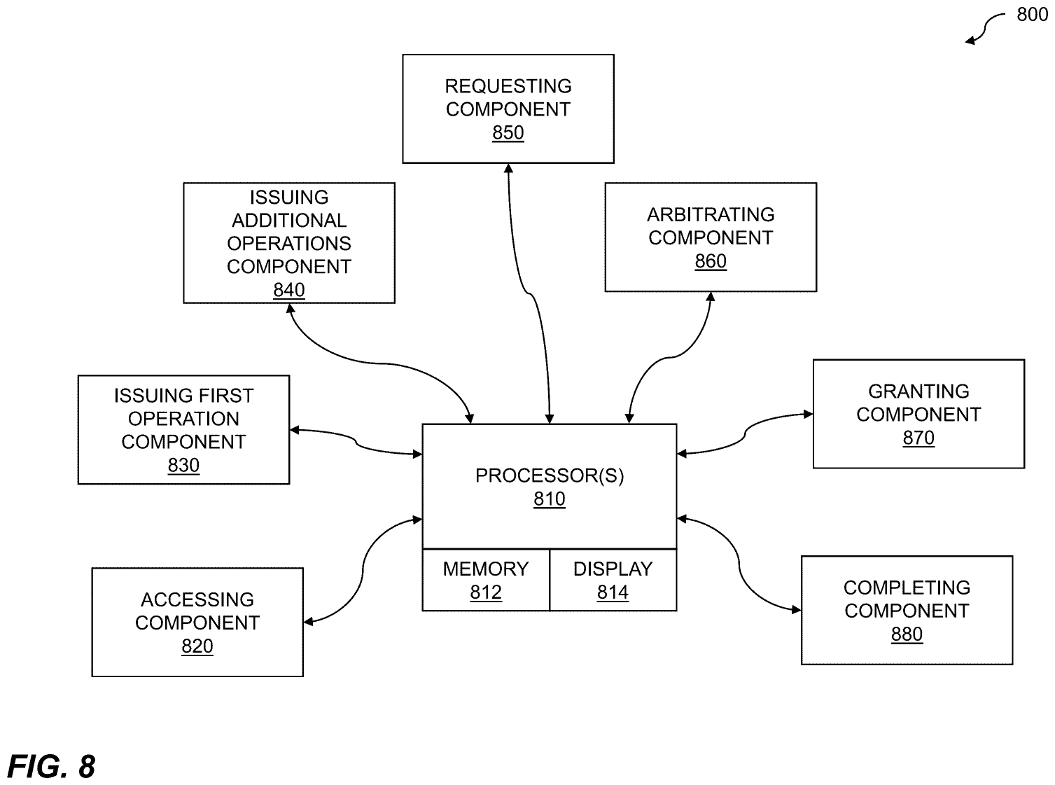

FIG. 8 is a system diagram for pipeline optimization with variable latency execution. The system 800 can include instructions and/or functions for design and implementation of integrated circuits that support pipeline optimization with variable latency execution. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 800 can include one or more processors 810. The processors can include standalone processors within integrated circuits or chips, processor cores in FPGAs or ASICs, and so on. The one or more processors 810 are coupled to a memory 812, which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores. In embodiments, the processor cores can include RISC-V™ processor cores.

The system 800 can include an accessing component 820. The accessing component 820 can include functions and instructions for accessing a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline. The processor core can include a RISC-V core, ARM core, MIPS core, and/or other suitable core type. The system 800 can include an issuing first operation component 830. The issuing first operation component 830 can include functions and instructions for issuing, by the issue queue, a first operation to a first execution engine within the execution pipeline, wherein the first operation is a variable latency operation. The system 800 can include an issuing additional operations component 840. The issuing additional operations component 840 can include functions and instructions for issuing, by the issue queue, one or more additional operations to one or more additional execution engines in the execution pipeline, wherein at least one of the one or more additional operations is a fixed latency operation. The system 800 can include a requesting component 850. The requesting component 850 can include functions and instructions for requesting, by a control logic, to the issue queue, to complete the first operation, when the first operation finishes execution within the first execution engine. The system 800 can include an arbitrating component 860. The arbitrating component 860 can include functions and instructions for arbitrating, by the issue queue, for an opening, wherein the opening is in the common write-back pipeline. In one or more embodiments, the arbitrating component 860 can enable recording of arbitration statistics in one or more registers of the register file. The arbitration statistics can include, but are not limited to, a percentage of variable latency instructions executed among the total number of instructions executed, a number of requests and grants that were issued, an average number of cycles between request and the corresponding grant, and so on. In one or more embodiments, the arbitration statistics can be used to generate metrics for performance profiling. The system 800 can include a granting component 870. The granting component 870 can include functions and instructions for granting, by the issue queue, to complete the first operation, wherein the granting is based on the arbitrating. The system 800 can include a completing component 880. The completing component 880 can include functions and instructions for completing the first operation, wherein the completing includes inserting, at the opening in the common write-back pipeline, a result of the first operation.

The system 800 can include a computer program product embodied in a non-transitory computer readable medium for instruction execution, the computer program product comprising code which causes one or more processors to generate semiconductor logic for: accessing a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline; issuing, by the issue queue, a first operation to a first execution engine within the execution pipeline, wherein the first operation is a variable latency operation; issuing, by the issue queue, one or more additional operations to one or more additional execution engines in the execution pipeline, wherein at least one of the one or more additional operations is a fixed latency operation; requesting, by a control logic, to the issue queue, to complete the first operation, when the first operation finishes execution within the first execution engine; arbitrating, by the issue queue, for an opening, wherein the opening is in the common write-back pipeline; granting, by the issue queue, to complete the first operation, wherein the granting is based on the arbitrating; and completing the first operation, wherein the completing includes inserting, at the opening in the common write-back pipeline, a result of the first operation.

The system 800 can include a computer system for instruction execution comprising: a memory which stores instructions; one or more processors coupled to the memory wherein the one or more processors, when executing the instructions which are stored, are configured to: access a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline; issue, by the issue queue, a first operation to a first execution engine within the execution pipeline, wherein the first operation is a variable latency operation; issue, by the issue queue, one or more additional operations to one or more additional execution engines in the execution pipeline, wherein at least one of the one or more additional operations is a fixed latency operation; request, by a control logic, to the issue queue, to complete the first operation, when the first operation finishes execution within the first execution engine; arbitrate, by the issue queue, for an opening, wherein the opening is in a common write-back pipeline; grant, by the issue queue, to complete the first operation, wherein the granting is based on the arbitrating; and complete the first operation, wherein the completing includes inserting, at the opening in the common write-back pipeline, a result of the first operation.

As can now be appreciated, disclosed embodiments provide techniques for pipeline optimization with variable latency execution, thereby enabling improved processor performance. Embodiments can include issue queue arbitration that utilizes a request-grant mechanism to create a slot in an execution pipeline. When a variable latency instruction completes, a request is generated to control logic. The control logic may stall one of the instructions in the pipeline to allocate the stages needed to complete the writeback portion of the variable latency instruction, while also providing a mechanism to pass the result of the variable latency instruction directly to subsequent dependent instructions. The instruction that is stalled can be a variable latency execution instruction or a fixed latency execution instruction. In this way, the subsequent dependent instructions can start earlier, by bypassing the writeback stage. Hence, with disclosed embodiments, completion of the writeback stage is not a criterion for execution of a dependent instruction. Accordingly, disclosed embodiments provide improvements in the technical field of instruction execution.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline;
issuing, by the issue queue, a first operation to a first execution engine within the execution pipeline, wherein the first operation is a variable latency operation;
issuing, by the issue queue, one or more additional operations to one or more additional execution engines in the execution pipeline, wherein at least one of the one or more additional operations is a fixed latency operation;
requesting, by a control logic, to the issue queue, to complete the first operation, when the first operation finishes execution within the first execution engine;
arbitrating, by the issue queue, for an opening, wherein the opening is in the common write-back pipeline;
granting, by the issue queue, to complete the first operation, wherein the granting is based on the arbitrating; and
completing the first operation, wherein the completing includes inserting, at the opening in the common write-back pipeline, a result of the first operation.

2. The method of claim 1 wherein the arbitrating comprises halting, by the issue queue, a pick stage for a second operation within the one or more additional operations.

3. The method of claim 2 wherein the inserting occurs at an execution stage of the common write-back pipeline.

4. The method of claim 3 wherein the execution stage is a second execution stage.

5. The method of claim 3 further comprising delivering the result of the first operation to an entry of the issue queue occupied by a depending operation, wherein the depending operation includes a dependency on the result of the first operation.

6. The method of claim 5 wherein the delivering is accomplished by a bypass path in the common write-back pipeline.

7. The method of claim 5 further comprising writing the results of the first operation, in a writeback stage of the common write-back pipeline, to a register file.

8. The method of claim 7 further comprising reading, from the register file, the results of the first operation.

9. The method of claim 1 wherein the arbitrating comprises stalling, by the issue queue, the first operation.

10. The method of claim 1 further comprising completing the one or more additional operations.

11. The method of claim 1 wherein the processor core includes one or more additional execution pipelines.

12. The method of claim 11 wherein each execution pipeline in the one or more additional execution pipelines includes a unique issue queue.

13. The method of claim 1 wherein the requesting, the arbitrating, the granting, and the completing include a second variable latency operation.

14. The method of claim 1 wherein the variable latency operation is identified by the issue queue.

15. The method of claim 1 wherein the variable latency operation is a floating-point square root operation.

16. The method of claim 1 wherein the variable latency operation is a floating-point divide operation.

17. The method of claim 1 wherein the execution of the variable latency operation is not pipelined.

18. The method of claim 1 wherein the processor core executes one or more instructions out of order.

19. A computer program product embodied in a non-transitory computer readable medium for instruction execution, the computer program product comprising code which causes one or more processors to generate semiconductor logic for:
accessing a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline;
issuing, by the issue queue, a first operation to a first execution engine within the execution pipeline, wherein the first operation is a variable latency operation;
issuing, by the issue queue, one or more additional operations to one or more additional execution engines in the execution pipeline, wherein at least one of the one or more additional operations is a fixed latency operation;
requesting, by a control logic, to the issue queue, to complete the first operation, when the first operation finishes execution within the first execution engine;
arbitrating, by the issue queue, for an opening, wherein the opening is in the common write-back pipeline;
granting, by the issue queue, to complete the first operation, wherein the granting is based on the arbitrating; and
completing the first operation, wherein the completing includes inserting, at the opening in the common write-back pipeline, a result of the first operation.

20. A computer system for instruction execution comprising:
a memory which stores instructions;
one or more processors coupled to the memory wherein the one or more processors, when executing the instructions which are stored, are configured to:
access a processor core, wherein the processor core supports variable latency operations and fixed latency operations, wherein the processor core includes an execution pipeline, wherein the execution pipeline is coupled to an issue queue, and wherein the issue queue is coupled to a common write-back pipeline;
issue, by the issue queue, a first operation to a first execution engine within the execution pipeline, wherein the first operation is a variable latency operation;
issue, by the issue queue, one or more additional operations to one or more additional execution engines in the execution pipeline, wherein at least one of the one or more additional operations is a fixed latency operation;
request, by a control logic, to the issue queue, to complete the first operation, when the first operation finishes execution within the first execution engine;
arbitrate, by the issue queue, for an opening, wherein the opening is in the common write-back pipeline;
grant, by the issue queue, to complete the first operation, wherein the granting is based on the arbitrating; and
complete the first operation, wherein the completing includes inserting, at the opening in the common write-back pipeline, a result of the first operation.
